(19) United States
(12) Patent Application Publication
(10) Pub. No.: US 2026/0183684 A1
(43) Pub. Date: Jul. 2, 2026

(54) Removable Cartridge Design with Threaded Center Tube

(71) Applicant: Parker-Hannifin Corporation, Cleveland, OH (US)

(72) Inventors: Kevin B. Downs, Coventry, CT (US); Wayne J. Dube, Woodstock Valley, CT (US); Bradford W. Fleming, Westfield, MA (US)

(73) Assignee: Parker-Hannifin Corporation, Cleveland, OH (US)

(21) Appl. No.: 19/548,649

(22) Filed: Feb. 24, 2026

Related U.S. Application Data
(63) Continuation of application No. PCT/US2024/042207, filed on Aug. 14, 2024.
(60) Provisional application No. 63/535,131, filed on Aug. 29, 2023.
(60) Provisional application No. 63/590,053, filed on Oct. 13, 2023.

(51) Int. Cl. B01D 29/33; B01D 35/30

(52) U.S. Cl. CPC B01D 29/33; B01D 35/306; B01D 2201/167; B01D 2201/291; B01D 2201/347; B01D 2201/4076; B01D 2201/4092

(57) ABSTRACT

A filter element is useable with a mounting bowl for mounting to a filtration header to provide for liquid filtration, for example fuel filtration. The filter element can have a central inlet passageway and/or a threaded center tube portion that may be used to perform separate functions such as allowing opening and closing of a drain valve on the mounting bowl to allow drainage and/or to facilitate mechanical advantage to translate the filter element relative to the bowl by a service mechanic during filter replacement. Additionally, this configuration also allows a water-in-fuel (WIF) sensor to be mounted into a stem portion of the drain valve.

### CROSS-REFERENCE TO RELATED PATENT APPLICATIONS

This Patent Application is a Continuation of Application No. PCT/US2024/042207, filed Aug. 14, 2024, which is now pending, the entire teachings and disclosure of which are incorporated herein by reference thereto. This Patent Application claims the benefit of U.S. Provisional Patent Application No. 63/590,053, filed Oct. 13, 2023; and also claims the benefit of U.S. Provisional Application No. 63/535,131, filed Aug. 29, 2023. The entire teachings and disclosure each of these listed patent applications are incorporated herein by reference thereto.

### FIELD OF THE INVENTION

This invention generally relates to filters and more particularly to liquid filters having a top end with inlet and outlet ports for receipt of dirty fluid and return of clean fluid.

### BACKGROUND OF THE INVENTION

Different liquid filters are shown that have an internal filter element and an external filter housing mounting bowl such as in U.S. Pat. No. 8,501,003 entitled Canister filter system with drain that cooperates with filter element; U.S. Pat. No. 8,932,462 entitled Oil filter conversion kit; U.S. Pat. Nos. 8,110,099; 3,259,247 entitled Filter; U.S. Pat. No. 3,370,707 entitled Oil filter, particularly for automotive vehicles; U.S. Pat. No. 5,788,859 entitled Self-evacuating water-separating fuel filter.

For example, U.S. Pat. No. 8,501,003 discloses that it illustrates a canister filter system having a base (i.e., filter header), a canister (i.e., mounting bowl with cylindrical sidewall as shown), and a filter element; and that the general construction and use of a canister filter system is understood by those of ordinary skill in this art. The '003 patent further details the provision of a drain at the bottom end that can facilitate drainage of fluid (e.g. water) from the mounting bowl. For example, it is known in the art to use a filter media that can coalesce and/or strip water from a fuel flow which is collected in the canister and can be drained by a vehicle/engine operator or service mechanic.

Yet another example of a fuel filter with a drain cock valve is shown in US Patent Publication No. 2007/0114170 entitled Fuel Filter Cartridge Apparatus to Krull et. al. In this and the '003 patent the drain cock valve has the same functionality to drain liquid (e.g., water) at the bottom on the canister.

In these examples of the '003 patent and '170 publication, the functionality of the drain cock valve appear limited to liquid drainage at the bottom end of the canister. Also these have closed bottom end caps that facilitate a flow path with inlet flow entering along the outside, with closed bottom end caps and require a specific flow path plumbing.

### BRIEF SUMMARY OF THE INVENTION

According to an aspect, a cartridge filter assembly is provided with a threaded center tube portion that may be used to perform three separate operations by rotating a valve knob clockwise and/or counterclockwise. A large diameter O-ring housed in the upper end cap creates friction between the cartridge housing and the upper end cap. Without the mechanical advantage of the threaded center tube it can be difficult to remove the filter from the cartridge housing without a tool.

It is a feature that the upper end cap has an internal thread through the center axis of the part, which threads onto the male thread of the center tube. When the center tube is rotated clockwise the cartridge is drawn downward in the cartridge housing (e.g. mounting bowl) and bottoms on a lip provided by a ledge. The process is reversed to remove the filter from the cartridge housing (the threaded center tube is turned counterclockwise).

According to an aspect, the filter assembly includes a header and a canister, a drain assembly associated with the canister, and a filter element removably located within the canister. The filter element includes i) a ring of media, ii) upper and lower end caps assemblies, each of which has a central annular body portion, and iii) a center support core. The upper end cap and/or the center support core includes an internal threaded segment. A flow channel is provided between the ring of media and the center support core, and a flow opening is provided in the central body portion of the upper end cap assembly into the flow channel.

It is a feature that seals such as O-rings are provided. A first O-ring is supported around the periphery of a distal end of the center support core projecting outwardly away from the upper end cap assembly for sealing with the inlet opening channel in the header. A second O-ring is supported around the periphery of a fluid tube radially-outwardly surrounding the center support core and also projecting outwardly away from the upper end cap assembly. The second O-ring seals with the header to provide an outlet flow path. The fluid tube is also radially outwardly spaced from the flow opening in the upper end cap assembly. A third O-ring is supported around the periphery of the central body portion of the first end cap assembly to seal against the canister.

The filter assembly may further feature a drain assembly including i) a hollow center tube inserted within the support core of the element, with a tubular body portion having an external threaded segment configured to threadably connect with the internal threaded segment in the center tube providing a support core of the filter element. At least one flow opening (i.e., hole) is provided along the length of the center tube, either internal to the media ring along the length of the media ring, or external to the media ring at the lower end of the canister. A flow channel is provided along the length of the center tube internal to the canister. The center tube extends through an opening in the bottom wall of the canister, and an enlarged knob is provided on the distal end of the center tube, external to the canister.

The external knob of the drain assembly is rotatable to i) attach and detach the threaded segment of the center support core of the filter element with the threaded segment of the tubular body portion of the drain assembly to enable the element to be assembled and disassembled from the canister, and ii) to open and close a flow opening between the center tube of the drain assembly and the opening in the bottom wall of the canister. The fuel flow path can be seen in the attached drawings.

According to an inventive aspect, a filter element comprises a ring of filter media; an upper end cap and a lower end cap, with the ring of filter media extending between the upper end cap and the lower end cap; an inlet entrance port and an outlet port at an upper end of the filter element, and an inlet exit port at a lower end of the filter element; a central conduit extending inside the ring of filter media, with the central conduit defining an inlet passageway passing through the upper end cap and the lower end cap and fluidically communicating between the inlet entrance port and the inlet exit port; and an outlet passageway between the central conduit and the ring of filter media and fluidically communicating with the outlet port.

According to another inventive a filter element, comprises: a ring of filter media; an upper end cap and a lower end cap, with the ring of filter media extending between the upper end cap and the lower end cap; a central conduit extending through the filter media providing a first passageway centrally through the filter element along an interior of the conduit and providing a second passageway along an exterior of the conduit toward one end of the filter element; and a threaded region defined by a radially inner surface of the central conduit along the first passageway.

Any of the aspects above may also have one or more of the following features in any of the below paragraphs. The features in the below paragraphs may be used alone and/or in combination with one or more the other features in any of the aspects above.

It is a feature that filter element may comprise a threaded region defined by a radially inner surface of the central conduit along the inlet passageway.

It is a feature that the filter element may comprise an annular step region in the central conduit between the threaded region and the inlet exit port.

It is a feature that the central conduit comprises a center tube portion radially inside of the ring of filter media. The center tube portion may be a unitary portion of the upper end cap, with the center tube portion having a tubular end engaging the lower end cap.

It is a feature that the central conduit is provided by respective portions of the upper end cap and the lower end cap, with the upper end cap providing the inlet entrance port and the lower end cap defining a central opening to provide the inlet exit port.

It is a feature that the upper end cap comprises an annular disc portion bonded to an upper end of the ring of filter media. The filter element may further comprise ribs projecting radially inward from the annular disc portion to an annular support region of the central conduit, with a through port is defined by openings between adjacent ribs communicating the outlet passageway therethrough from a central filtered chamber inside of the ring of filter media to the outlet port.

It is a feature that the filter element may comprise a nipple portion. The nipple portion can comprise an inner annular wall and an outer annular wall, with the outer annular wall concentric with the inner annular wall. The inner annular wall and the outer annular wall project above an annular disc portion of the upper end cap, with the inner annular wall being an end portion of the central conduit.

It is a feature that the filter element may comprise radial seals, including an outlet radial seal carried by the outer annular wall and an inlet radial seal carried by the inner annular wall, and an element radial seal carried by the upper end cap at a radial outer periphery of the upper end cap.

In the above feature, the radial seals may be provided by respective elastomeric gaskets retained in respective retainer grooves. Each of the retaining grooves may be defined by the upper end cap.

In the nipple portion feature, the nipple portion may be unitary part with the upper end cap, including being unitary with a center tube portion of the conduit and the annular disc portion as a single piece component.

It is a feature that the upper end cap may provide a torsion lock detent along an upper surface thereof.

It is a feature that the upper end cap provides a key along a radial outward facing periphery thereof.

It is a feature that the central conduit is imperforate providing a leak-free path between the inlet entrance port and the and the inlet exit port.

It is a feature that the central conduit is provided by a combination of the upper end cap and the lower end cap.

It is a feature in a potted end cap embodiment that: (a) the upper end cap comprises an annular disc portion, an inner annular retainer wall and an outer annular retainer wall that together define an upper annular potting well, further comprising adhesive sealing and bonding an upper end of the ring of filter media to the upper end cap; and (b) the lower end cap comprises an annular disc portion, an inner annular retainer wall and an outer annular retainer wall that together define a lower annular potting well, further comprising adhesive sealing and bonding a lower end of the ring of filter media to the lower end cap.

It is a feature according to an embodiment that the central conduit comprises a center tube portion radially inside of the ring of filter media, with the center tube portion being a unitary portion of the lower end cap.

It is a feature according to an embodiment that the central conduit comprises a center tube portion radially inside of the ring of filter media, with the center tube portion being a separate tube member joined to the bottom end cap and extending through an annular disc portion of the upper end cap.

It is a feature according to an embodiment that the upper end cap is a composite end cap comprising two component parts arranged together to provide the inlet entrance port and the outlet port at the upper end of the filter element.

It is a feature according to a preferred embodiment, that the upper end cap is a unitary single piece end cap unitarily providing both the inlet entrance port and the outlet port at the upper end of the filter element.

It is a feature according to an embodiment that the central conduit comprises a center tube portion radially inside of the ring of filter media, wherein the center tube portion is joined to an annular disc portion of the lower end cap and extends through annular disc portions of the upper and lower end caps, respectively.

It is a feature for the first/second passageways that the first passageways is an inlet passageway for unfiltered fluid and the second passageway is an outlet passageway for filtered fluid, with the filter element having a predetermined flow path through the inlet passageway then through the ring of filter media, and then through outlet passageway.

It is a feature that the central conduit can comprise an annular step region between the threaded region and the inlet exit port.

It is a feature that the central conduit comprises a center tube portion radially inside of the ring of filter media, preferably with the center tube portion being a unitary portion of the upper end cap and with a tubular end engaging the lower end cap.

It is a feature that the filter element is implement into a filter cartridge.

In the above feature, the filter cartridge may comprise: a mounting bowl comprising a cylindrical sidewall and a bottom end wall that together define an element chamber, with the cylindrical sidewall having a mounting thread, the bottom end wall defining a central drain opening. The filter element can be installed into the element chamber in spaced relation to the bottom end wall to provide a drain chamber between the filter element and the bottom end wall, with a seal between the filter element and the cylindrical sidewall of the mounting bowl to prevent fluid leakage from the bowl. The filter cartridge may further comprise a drain valve mounted through the central drain opening and having a stem portion engaging the central conduit of the filter element, the stem portion extending from a knob that resides on the outside of the mounting bowl.

It is a feature in such filter cartridge that the filter element may comprise a threaded region defined by a radially inner surface of the central conduit along the inlet passageway. The stem portion of the drain valve can comprise a mating thread engaging the threaded region such that the drain valve can be screwed and axially driven between an open position allowing drainage of fluid from the central drain opening and closed position sealing the central drain opening and the element chamber, and thereby sealing off a valve port between an exterior of the stem portion and an inner face of the central drain opening.

It is a feature in such filter cartridge that the stem portion defines an internal sensor cavity and defines holes therein communicating the internal sensor cavity with the drain chamber. The cartridge further comprises a water-in-fuel (WIF) sensor mounted into the sensor cavity for sensing water in the drain chamber.

It is a feature in such filter cartridge that the filter element is removably mounted into the bowl and not permanent therewith such that the filter element is disposable and the bowl is reusable.

It is a feature in such filter cartridge that a keyed arrangement is provided. The keyed arrangement includes a key projection and a key slot on the filter element and the mounting bowl, respectively or vice versa. The keyed arrangement rotationally locks the filter element and the mounting bowl.

It is a feature in such filter cartridge that the mounting bowl defines an annular ledge providing a seating surface at an upper end of the cylindrical sidewall. The upper end cap can be seated upon the seating surface. Furthermore, rotation of the knob in one rotational direction is operable to lift the filter element from the seating surface.

According to a further feature, the filter cartridge can be incorporated into a filtration assembly for filtering liquid, which assembly further comprises a filter header. The filter headers comprises: (a) a base portion defining an unfiltered inlet and a filtered outlet, with the unfiltered inlet communicating unfiltered liquid to the inlet entrance port and the outlet port communicating filtered liquid to the unfiltered outlet; and (b) a mounting rim extending from the base portion defining a rim thread for mating and engaging with the mounting thread to releasably mount the filter cartridge to the filter header.

It is a feature in such filtration assembly that the filter header further comprises concentric cylindrical inner and outer fluid connection walls connected to the unfiltered inlet and the filtered outlet, respectively. Furthermore, the filter element can comprise a nipple portion. The nipple portion can comprise an inner annular wall and an outer annular wall, with the outer annular wall concentric with the inner annular wall. The inner annular wall and the outer annular wall project above an annular disc portion of the upper end cap. In the assembly, the inner annular wall sealingly engages the cylindrical inner fluid connection wall and the outer annular wall sealingly engages the cylindrical outer fluid connection wall.

It is a feature in such filtration assembly that the assembly comprises a torsion detent locking system. For example, the torsion detent locking system can include a spring actuated lock on the filter head and a torsion lock detent on the filter cartridge configured to torsion lock the filter cartridge to the filter header when the rim thread is mated and engaged with the mounting thread.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front view of a filtration assembly according to an embodiment of the present invention;

FIG. 2 is a side view of the filtration assembly shown in FIG. 1;

FIG. 3 is a rear view of the filtration assembly shown in FIG. 1;

FIG. 4 is a vertical cross section through the filtration assembly of FIG. 1;

FIG. 5 is a vertical cross section through the filter cartridge of the filtration assembly shown in FIG. 4 with the filter element shown in a seated position on the mounting bowl;

FIG. 6 is a vertical cross section through the filter cartridge the same as shown in FIG. 5 except with the filter element elevated off of the seated position from the mounting bow due to rotation of the knob via the threaded engagement;

FIG. 7 is a vertical cross section through the filter cartridge the same as shown in FIG. 6 except with the filter element elevated off of the seated position from the mounting bow even further and out of threaded engagement but with keyed arrangement therebetween for torque transfer and alignment;

FIG. 8 is another vertical cross section through the filter cartridge the same as shown in FIG. 5, except that it is through a vertical cross section perpendicular to that of FIG. 5, and enlarged to better show top end and shown in perspective;

FIG. 9 is an isometric view of the mounting bowl for the filter cartridge shown in prior figures;

FIG. 10 is a vertical cross section through the filtration assembly and the same as FIG. 4 but with FIG. 10 showing the drain valve open as compared to the drain valve closed in FIG. 4;

FIG. 11 is another a vertical cross section through the filtration assembly similar as FIG. 4, but with additional flow path arrows schematically illustrating a fluid (e.g. fuel) flow pathways through the filtration assembly;

FIG. 12 is an isometric view of the filter element of the filter cartridge shown in prior figures;

FIG. 13 is a top view of the filter element shown in FIG. 12;

FIG. 14 is a bottom view of the filter element shown in FIG. 12;

FIG. 15 is side exploded assembly view of the filter element shown in FIG. 12;

FIG. 16 is an isometric exploded assembly view of the filter element shown in FIG. 12;

FIG. 17 is a vertical cross section of the filter element shown in FIG. 12;

FIG. 18 is front exploded assembly view of the filtration assembly shown in FIG. 1;

FIG. 19 is an isometric exploded assembly view the filtration assembly shown in FIG. 1;

FIG. 20 is a vertical cross section through the drain valve of the filtration assembly shown in FIG. 1;

FIG. 21 is an isometric view of the drain valve shown in FIG. 20 viewed more from the bottom;

FIG. 22 is an isometric view of the drain valve shown in FIG. 20 viewed more from the top, and with additional flow opening holes according to a further embodiment;

FIG. 23 is a front view of an alternative embodiment of a filtration assembly the same as that of FIG. 1, except that the embodiment of FIG. 23 has a drain valve without a water-in-fuel (WIF) sensor, which FIG. 1 does have;

FIG. 24 is a first alternative embodiment of a filter element to that shown in FIG. 12 and the same as that of FIG. 12 other than as described herein and usable in the filtration assembly of FIG. 1 or 23;

FIG. 25 is a first alternative embodiment of a filter element to that shown in FIG. 12 and the same as that of FIG. 12 other than as described herein and usable in the filtration assembly of FIG. 1 or 23;

FIG. 26 is a first alternative embodiment of a filter element to that shown in FIG. 12 and the same as that of FIG. 12 other than as described herein and usable in the filtration assembly of FIG. 1 or 23; and

FIG. 27 is a first alternative embodiment of a filter element to that shown in FIG. 12 and the same as that of FIG. 12 other than as described herein and usable in the filtration assembly of FIG. 1 or 23.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

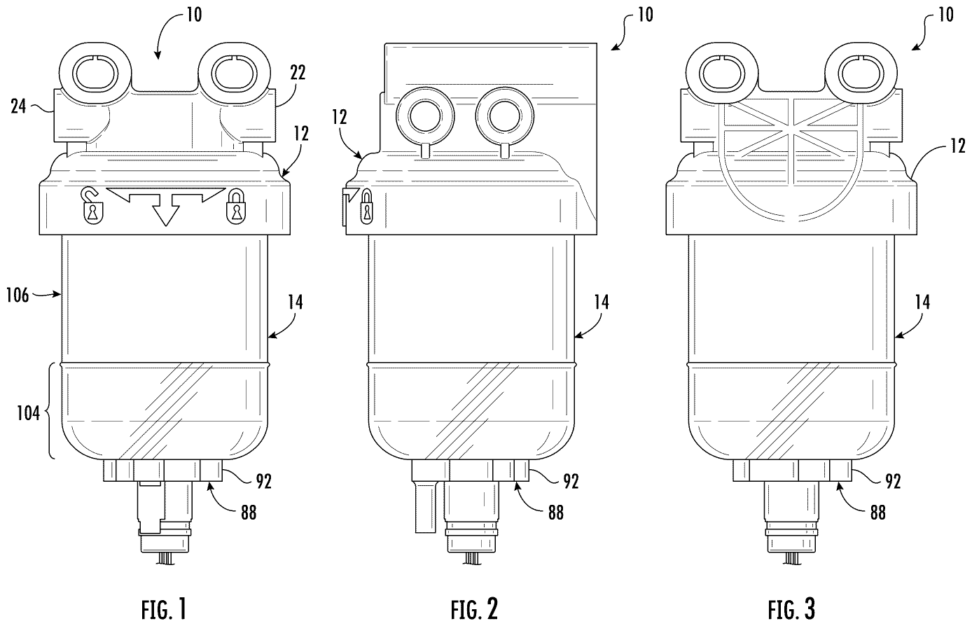

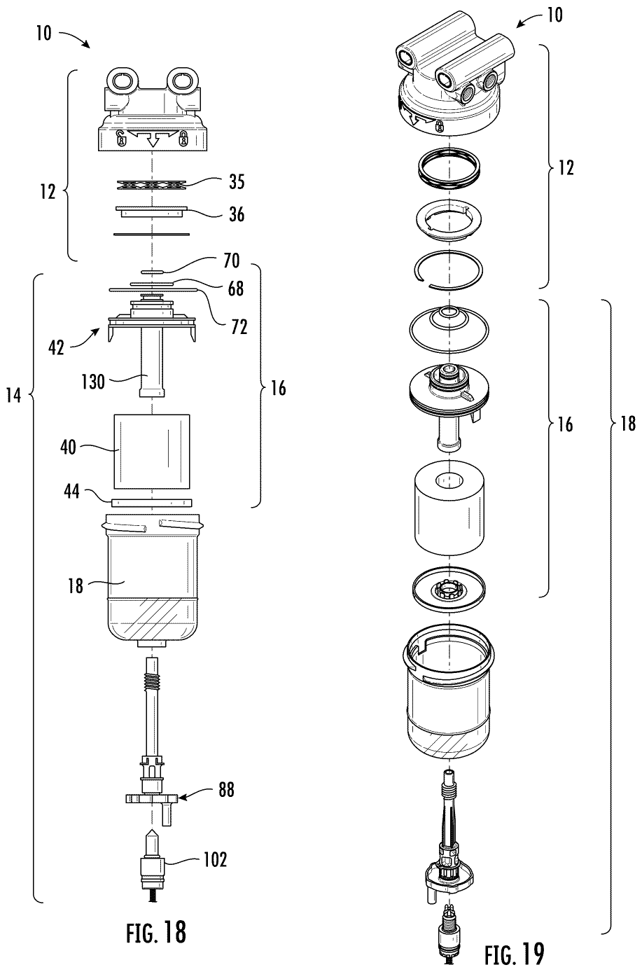

Referring to FIGS. 1-4, 18 and 19, an embodiment of the present invention has been illustrated as a filtration assembly 10, comprising a filter header 12 and a filter cartridge 14, which incorporates a replaceable filter element 16. In general, the filter cartridge 14 can be removably mounted to the filter header 14 such as via a releasable threaded connection and torsion lock; and the filter element 16 may be removably and replaceable from the mounting bowl 18 (e.g., plastic injection molded canister as shown) of the filter cartridge 14 as shown in the illustrated embodiment. However, an embodiment in which the filter element is permanently installed in the mounting bowl such that the entire cartridge is replaceable is also within the scope herein, though it is a less preferred embodiment as the preferred embodiment affords reusability of the mounting bowl.

Before turning to details and features of the filter element and/or filter cartridge, attention will first be had to the filter header 12. The filter header 12 comprises a base portion 20 defining an unfiltered inlet 22 and a filtered outlet 24. The unfiltered inlet 22 communicates unfiltered liquid (for example typically fuel for particulate and/or water separation but could also be oil or other liquid) received from a source (for example, a fuel tank) toward an inlet entrance port of the filter element 16. The unfiltered outlet 24 receives filtered liquid from the outlet port of the filter element 14 and communicates and returns filtered fluid having passed through filter media of the filter element 14 toward the desired application (for example, toward an engine for combustion).

The filter header 12 also has a cartridge mount, for example, a mounting rim 26 extending from the base portion 20 and defining a rim thread 28 (that may comprise one or more thread portions, with two thread portions for a half-turn install shown) for engaging with a complimentary mounting thread 30 of the mounting bowl 28 to releasably mount the filter cartridge 30 to the filter header 12.

To facilitate fluid flow interfacing with the filter element 14 and filter cartridge 16, the filter header 12 further comprises concentric cylindrical inner and outer fluid connection walls 32, 34 connected to the unfiltered inlet 22 and the filtered outlet 24, respectively. The connection walls 32, 34 are shown to depend downwardly and freely from the central region of the filter header base portion 20 as shown.

A further that can be employed is comprising a torsion detent locking system including a spring 35 actuated lock 36 on the filter head and a torsion lock detent 38 on the filter cartridge 14, configured to torsion lock the filter cartridge 14 to the filter header 12 when the rim thread 28 is mated and engaged with the mounting thread 30.

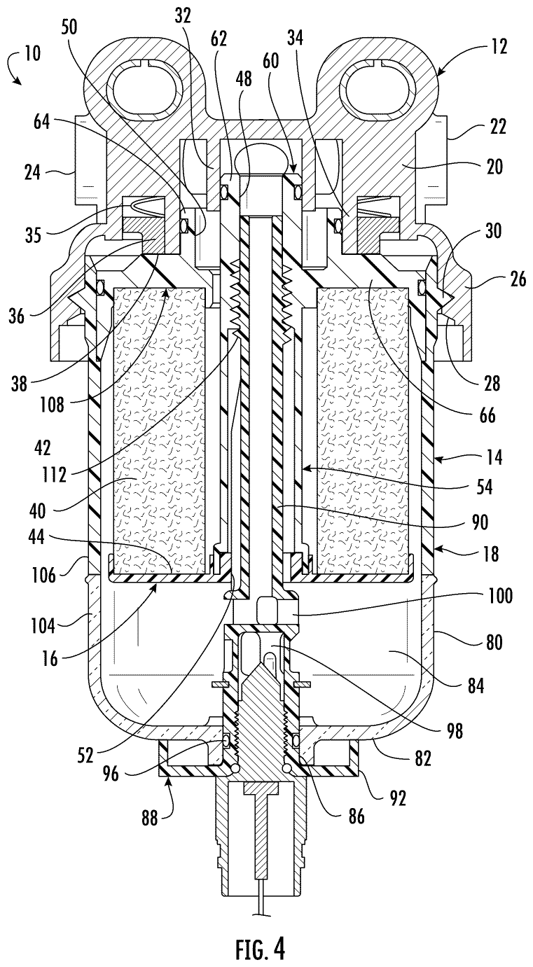

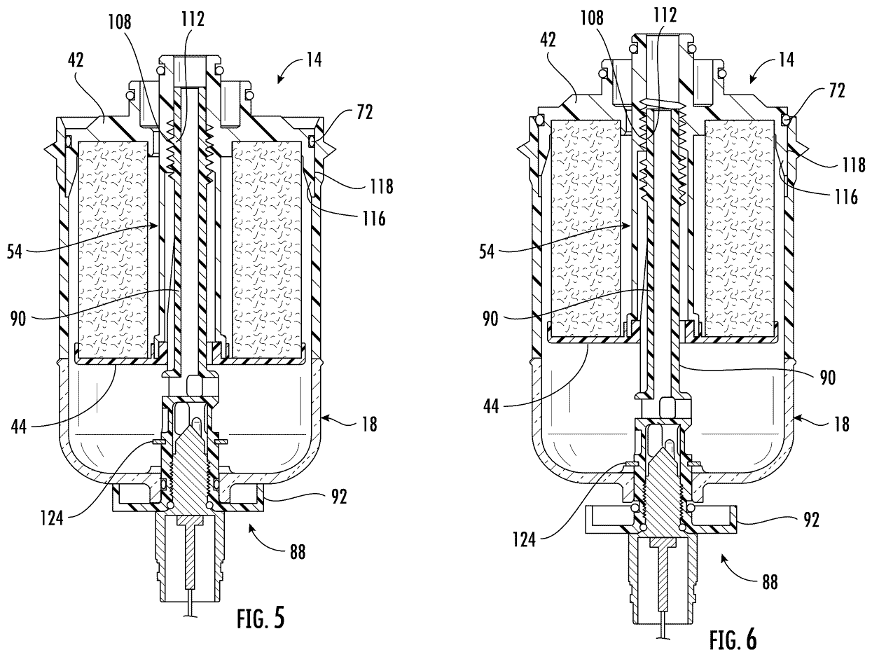

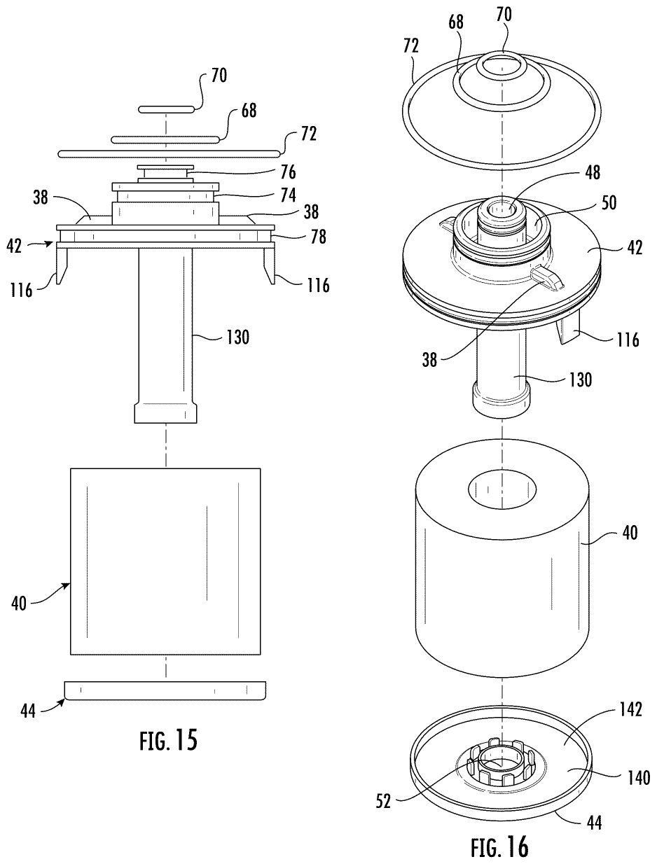

For example, in this embodiment, the torsion lock detent 38 is in the form of a radially extending tab extending from the top end of the filter element 16 of filter cartridge 14 as shown best in FIG. 16, with engagement shown in FIG. 4, and the lock is an axial slider mounted in a slide cavity in the filter header 12. Further details and different embodiments of torsion lock detents and locks may be used such as in the various embodiments shown and described in U.S. Pat. No. 11,731,065 to Downs and/or U.S. Pat. No. 11,731,065 to Rookey et. al., the entire disclosures of which are hereby incorporated by reference to show different types, locations and alternatives of torsion lock detents that may be employed according to this disclosure.

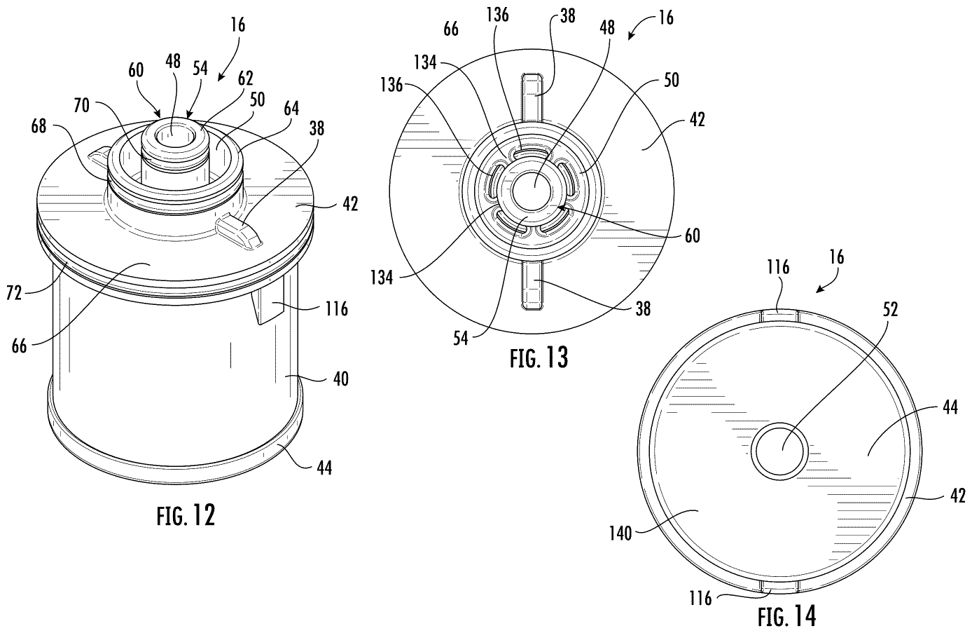

Turning to greater detail of the filter element 16, with reference to FIGS. 12-17, the filter element 16 comprises, comprises a ring of filter media 40. For example, the ring of filter media 40 maybe a pleated filter media of cellulose and/or synthetic fibers for filtration of particulates and that may be of a sufficient tightness and/or with hydrophobic additives to filter and coalesce water.

Additionally, the filter element 16 comprises an upper end cap 42 and a lower end cap 44, with the ring of filter media 40 therebetween. The end caps 42 can serve to cap and seal opposing ends of the ring of filter media 40 and/or facilitate fluid connections/flow passageways at opposite ends of the ring of filter media 40.

To facilitate attachment and to prevent leakage, the end caps 42, 44 are preferably sealingly bonded to opposite ends of the ring of filter media 40 such as via different options including: (a) potting adhesive 46 (e.g. plastisol, urethane, hot melt, glue, or other adhesive) as shown in which the potting adhesive is deposited into annular wells in the end caps as shown and/or (b) directly embedded such as via molded in place end cap and/or (c) directly embedded via a preform plastic end cap that has the inner surface melted (e.g. via radiant heat and/or ultrasonic energy) and directly embedded into the end(s) of the he ring of filter media 40. While metal or other materials for end caps are possible, preferably both end caps 42, 44 are plastic injection molded parts as shown by the plastic cross-hatch (e.g. alternative thin and thick line hatch).

The filter element facilitates fluid flow with an inlet entrance port 48 and an outlet port 50 at an upper end of the filter element 16 (for example, provided by the upper end cap 42), and an inlet exit port 52 at a lower end of the filter element (for example, provided by the lower end cap 44). The filter element 16, also provides a central conduit 54 (e.g., by extending inside the ring of filter media 40). The central conduit 54 defines an inlet passageway 56 of the filter element 16 passing through the upper end cap 42 and the lower end cap 44 and fluidically communicating between the inlet entrance port 48 and the inlet exit port 52. Further an outlet passageway 58 is provided between the central conduit 54 and the ring of filter media 40 that fluidically communicates with the outlet port. 50.

As shown for example, the central conduit 54 is imperforate providing a leak-free path between the inlet entrance port 48 and the and the inlet exit port 52. By “imperforate” it is meant that unfiltered fluid flow is not permitted (but does allow for the possibility of a normally closed pressure relief bypass valve), and in that way during normal operation unfiltered liquid enters the cartridge from the filter header and filtered liquid is returned to the filter header without adverse contamination by the unfiltered liquid.

In this embodiment, the fluid flow interface with the filter header 12 is facilitated by the filter element 16, which as shown in FIGS. 12-17 comprises a nipple portion 60. The nipple portion 60 comprises an inner annular wall 62 and an outer annular wall 64 The outer annular wall 64 is concentric with the inner annular wall 62. Each of the inner annular wall 62 and the outer annular wall 64 project above an annular disc portion 66 of the upper end cap 42 as shown.

The inner annular wall 62 is configured to sealingly engage with the inner connection wall 32 of the filter header 12 and the outer annular wall 64 sealingly engages the outer connection wall 34 of the filter head 12.

To better enhance sealing, seals are provided by the filter element 14 at the nipple portion 60 such that at filter replacement, fresh interface seals are provided. While axial seals may be used in embodiments, preferably, the filter element employs radial seals 68, 70. This can include outlet radial seal 68 carried by the outer annular wall 64 and an inlet radial seal 70 carried by the inner annular wall 62.

Additionally, when a reusable mounting bowl 18 is employed, an element radial seal 72 is provided to seal with the mounting bowl 18 at an interface therebetween to avoid liquid leakage to the outside. This element seal could alternatively be an axial seal, and would not be needed if the mounting bowl was integral with the filter element (e.g. attached by a ring of adhesive or otherwise integral/unitary at the top end.

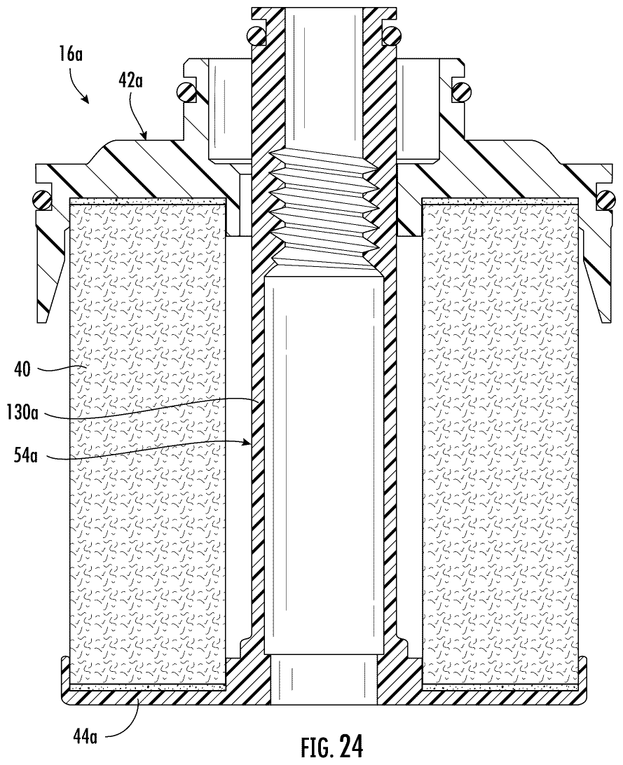

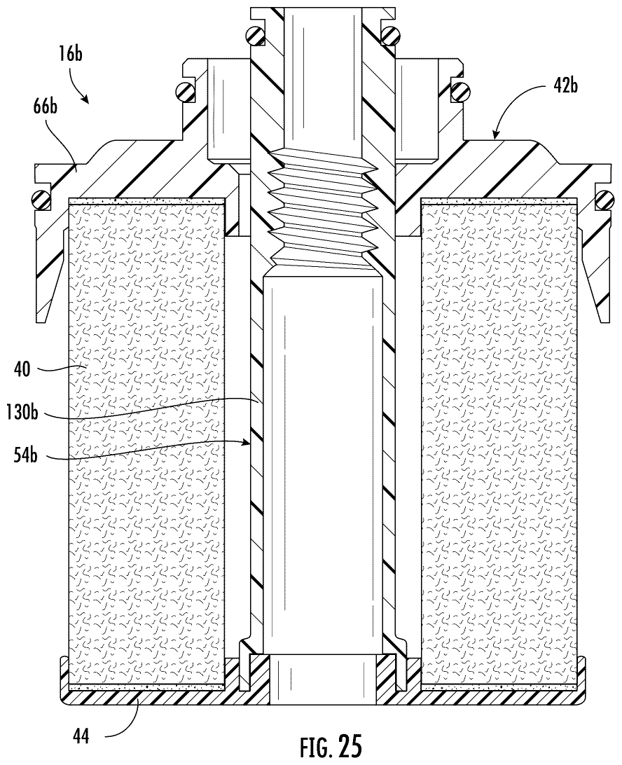

Preferably and as shown, the radial seals 68, 70, 72 are provided by respective elastomeric gaskets retained in respective retainer grooves 74, 76, 78, with each of the retaining grooves are defined by the upper end cap 42 as shown in the present embodiment of FIGS. 12-17 with a unitary upper end cap example and as also shown by alternative composite upper end cap of FIGS. 24-27. Foe example, the radial seals 68, 70, 72 are shown as O-ring gaskets or elastomeric material.

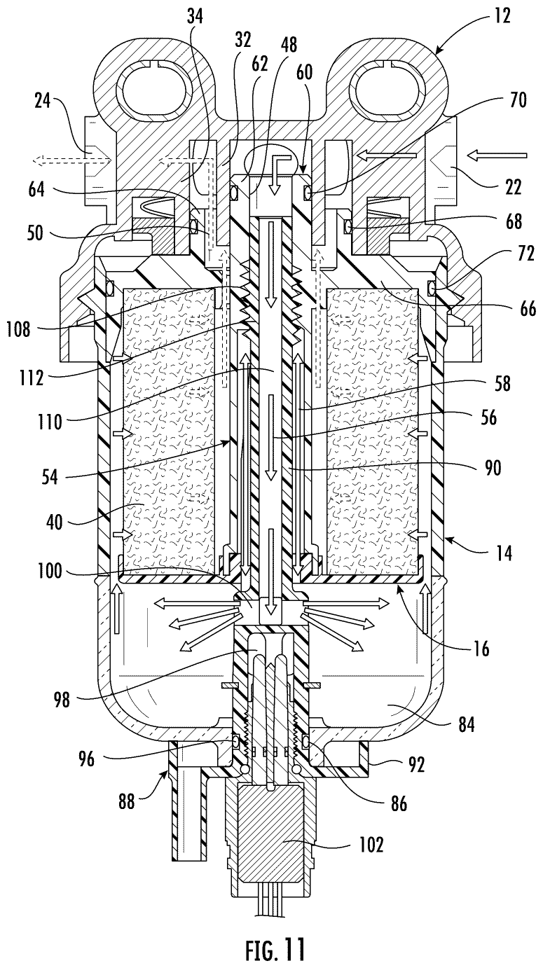

With the above discussion, the filtration operation through the filter element 16 is evident and between shown in FIG. 11 when shown in combination with the filter header 12 and remainder of the filter cartridge 14. Referring to remaining details of the filter cartridge, the mounting bowl 18 comprises a cylindrical sidewall 80 and a bottom end wall 82 that together define an element chamber 84 for receiving the filter element 16.

If the filtration system is a fuel filter, typically chamber 84 will also provide an unfiltered fluid chamber than can contain liquid such as fuel to be filtered, but also a collection chamber for contaminants such as a water collection chamber for water that may be coalesced and separated the ring of filter media 40 along the outside thereof if the filter is a fuel filter.

As shown, the cylindrical sidewall has the mounting thread 30 (that is complimentary to the filter header rim thread 28 for releasably securing the cartridge to the filter header and in this case for example includes two thread portions 180 degrees apart for a 1/2 turn install and release.

Further, the bottom end wall 82 in the case of a fuel filter will typically define a central drain opening 86 as shown to facilitate water drainage from a sump region at the gravitational bottom and/or to facilitate installation of a water-in-fuel (WIF) sensor.

The filter element 16 is installed into the element chamber 84 in spaced relation to the bottom end wall 82 to create adequate collection space of a drain chamber between the filter element and the bottom end wall. As discussed above, an element seal 72 between the filter element 16 and the cylindrical sidewall 80 of the mounting bowl prevent fluid leakage from the bowl to the external environment. Alternatively, a seal could be between the header and the cartridge at this location, but that can be avoided with the element seal 72.

Finally in the case of a fuel filter as shown, a drain valve 88 is mounted through the central drain opening 86. Drain valve 88 has a stem portion 90 engaging the central conduit 54 of the filter element 16. The stem portion 90 may extend from a knob 92 that resides on the outside of the mounting bowl 18. The knob can be manually operated 92 to axially drive the valve via a threaded connection as discussed below.

The drain valve has an open position shown in FIG. 6 to facilitate drainage of separated water from the sump region of the mounting bowl 18 via axially extending channels 94 formed into the outer surface of the stem portion 90 and a closed position as shown in FIG. 5, preferably with an O-ring gasket type seal 96 situated in an annular groove of the stem portion that can seal between the drain valve 80 and the inner surface of the drain opening 86 to prevent fluid leakage from the drain opening during normal operation when closed.

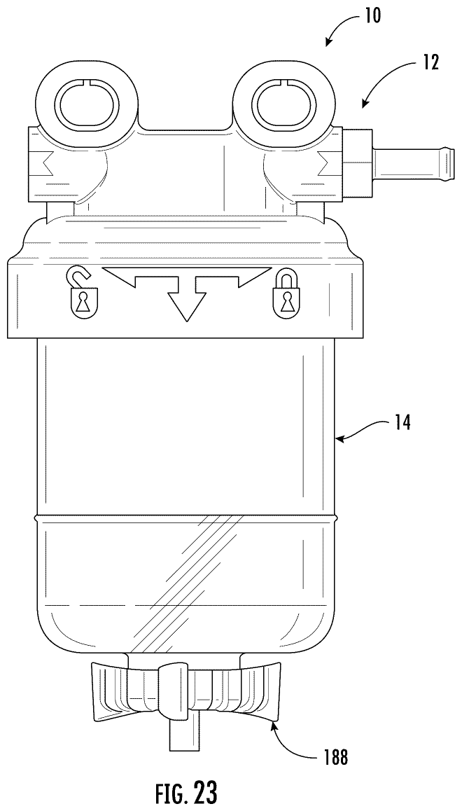

The stem portion 90 defines an internal sensor cavity 98 and defines holes 100 therein communicating the internal sensor cavity 98 with the drain chamber 84. Further, a water-in-fuel (WIF) sensor 102 is mounted into the sensor cavity 98 for sensing water in the drain chamber 84. Alternatively, a sensorless version of the drain valve 188 maybe employed as shown in FIG. 23 that may otherwise be the same as that as drain valve 88 such that the discussion of drain valve 88 is applicable to the embodiment of FIG. 23 other than for the water-in-fuel (WIF) sensor 102 features.

Holes 100 and a hollow inlet through cavity 110 in the stem portion 90 also ensure that the inlet passageway 56 is not blocked but maintained open, so that unfiltered fluid can flow from the filter header 12 centrally through the filter element 16 and into the region between the filter element 14 and the mounting bowl 18.

To provide additional visual indication and to help allow opening and closing decisions for the drain valve the mounting bowl 18 can be a single piece/part of a two part over molded plastic construction with a transparent region 104 at least proximate the bowl bottom and an opaque region at the upper end. Alternatively, the entire bowl could also be transparent or opaque. However, having at least part or all transparent allows a service mechanic or engine/vehicle operator to view through the cartridge like a window to see if water has collected and needs drained and to help identify when the drain valve can be closed during water drainage.

To facilitate various features including positive seating/unseating of the filter element 16 from the mounting bowl 18, and/or drainage of liquid through the drain opening 86, a threaded interface is provided.

For example, the filter element 16 comprises a threaded region 108 (for example a single continuous helical thread) defined by a radially inner surface of the central conduit 54 along the inlet passageway 56. Further, the stem portion 90 comprises a mating thread 112 engaging the threaded region 108 such that the drain valve 88 can be screwed and axially driven between the open position (FIG. 6) allowing drainage of fluid from the central drain opening 86 and closed position sealing the central drain opening 86 and the element chamber 84 (and thereby the valve port between an exterior of the stem portion and an inner face of the central drain opening).

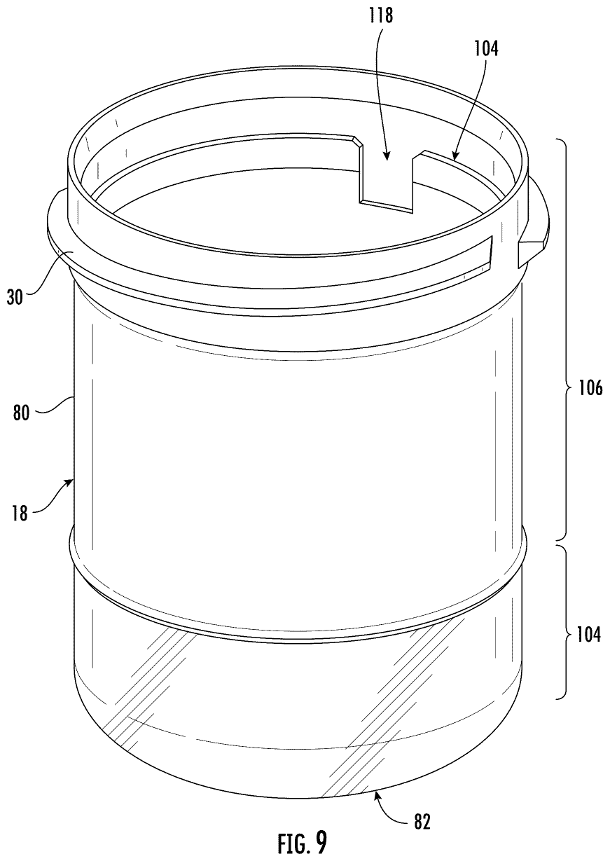

As alluded to above, the filter element can be removably mounted into the bowl and not permanent therewith such that the filter element is disposable, and the bowl is reusable. In this regard, the threaded region 108 and the mating thread 112 can be used to seat and unseat the filter element 16 from the mounting bowl 18 as can be seen FIGS. 5, 6, 7 and 8. Operating (e.g. twisting) the knob 92 facilitates screwing/unscrewing the drain valve 88 can drive the filter element toward or away from the bottom end of the cartridge bowl as shown in these figures. There is a positive stop as well, wherein the mounting bowl defines an annular ledge 114 providing a seating surface at an upper end of the cylindrical sidewall 80. The outer circular periphery of the upper end cap 42 seats upon this seating surface when fully installed.

To better ensure rotation results in axially driving the mounting bowl 18 and the filter element 16, the drain valve axially abuts the mounting bowl 18.

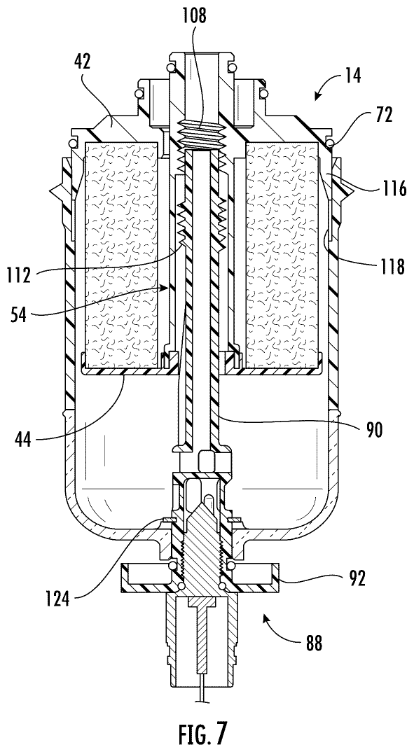

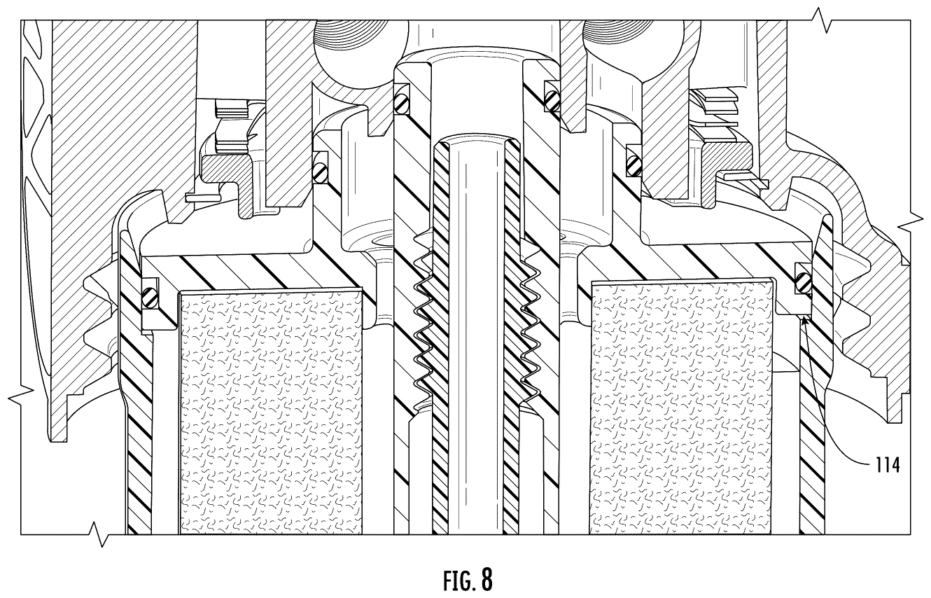

For example, as shown the valve stem portion 90 has an abutment flange 124 that may be provided by a snap ring seated in a groove defined by the stem portion 90. The abutment flange 124 is positioned inside the bowl and sized larger than the drain open 86 to engage the bottom end wall 82 surrounding the drain opening 86 as can be seen in FIGS. 6 and 7.

As shown in FIG. 5, the abutment flange 124 may be spaced from the bottom end wall 82 when the drain valve is closed; and then once the drain valve is open as shown in FIG. 6, the abutment flange 124 can engage the bottom end wall 82, at which point further rotation of the knob can drive the filter element and the mounting bowl axially away from each other.

Additionally, to prevent relative rotation between the cartridge mounting bowl 18 and the filter element 16 to allow for the axial translation therebetween during screwing operation of the knob 92 (and also for alignment for torsion locking with the filter header 12), there is a keyed arrangement. For example, a key projection 116 (e.g. two 180 degree apart axial tabs) and a key slot 118 (e.g. two 180 degree apart axial grooves) on the filter element and the mounting bowl, respectively or vice versa. In either case the keyed arrangement rotationally locks the filter element and the mounting bowl.

Various features may be evident on the filter cartridge.

The filter element 16 includes a threaded region 108 defined by a radially inner surface of the central conduit 54 along the inlet passageway 56.

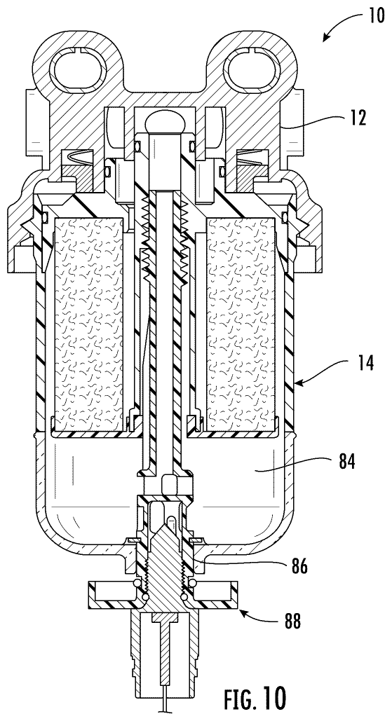

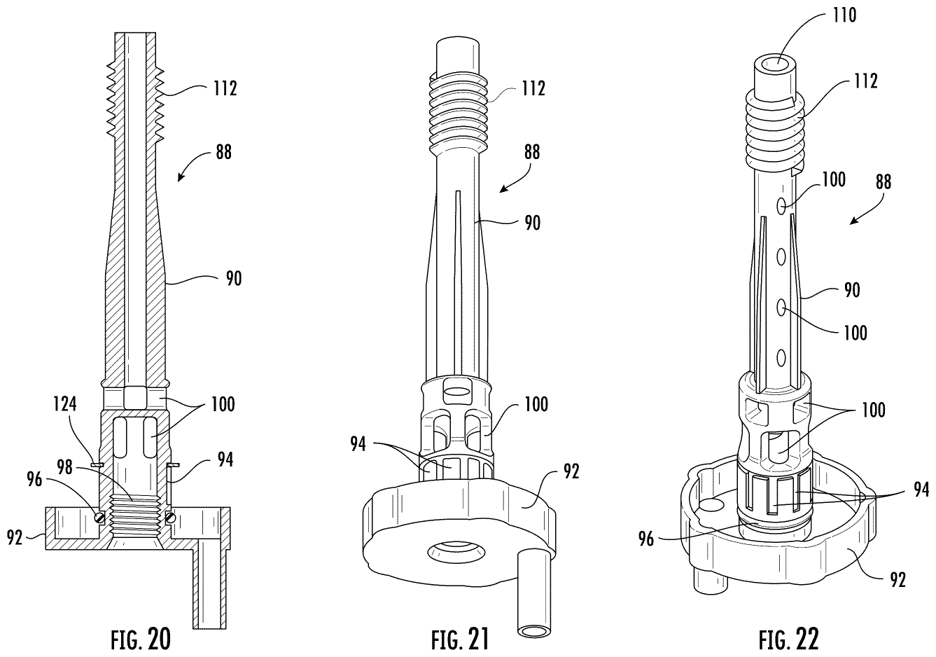

Although alternative embodiments do separately as shown in FIGS. 24-27, preferably this threaded region 18 is defined by a one-piece unitary upper end cap 42 as shown in FIGS. 1-22, which prevent tolerance/precision issues with stacking of parts. In particular, the threaded region 108 has particular accuracy and precision relative to the outer periphery and seals carried by the single piece end cap and intermediate separate parts do not cause additional stacking tolerance or imprecision.

The filter element 16 may comprise one or more annular step regions 120, 122 in the central conduit between the threaded region and the inlet exit port. For example, the upper step region 120 provides additional wall thickness to facilitate room for threaded region 108. For example, the lower step region 120 may provide for seating and stacking between upper and lower end caps 42, 44.

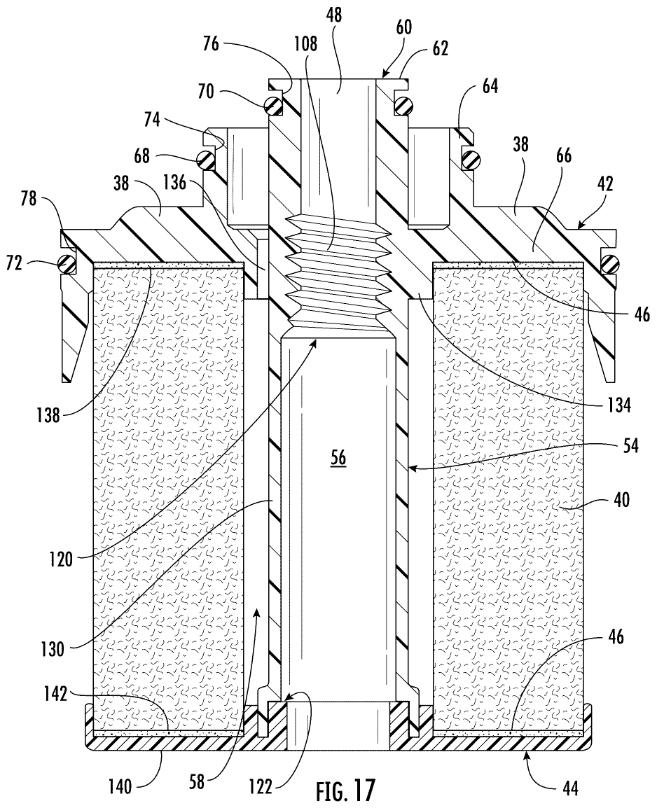

As shown in FIGS. 16 and 17 (and also FIGS. 24-27, the central conduit 54 comprises a center tube portion radially inside of the ring of filter media 40. As shown in FIGS. 16 and 17, the center tube portion 130 is a unitary portion of the upper end cap 42 as a single piece part, with the center tube portion 130 having a tubular end engaging the lower end cap. For example, the center tube portion 130 can be received and sealed via adhesive in an annular groove 132 defined by the lower end cap 44.

As such to provide upper and lower end caps 42, 44 along with center tube portion 130 (and the conduit 54), only two component parts may be needed as is preferred as shown in FIG. 17 and also FIG. 24 embodiment (although more pieces may be used in composite implementations as shown in FIGS. 25-27 alternative embodiments).

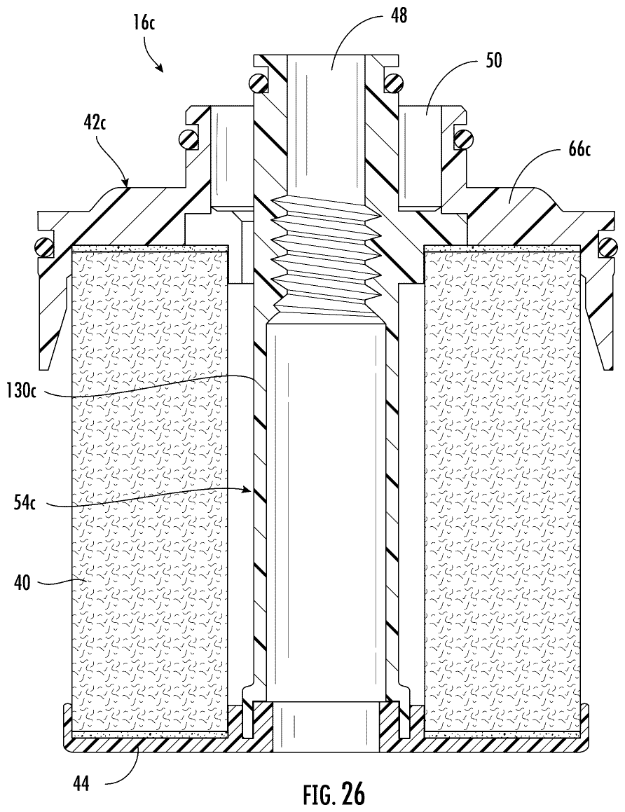

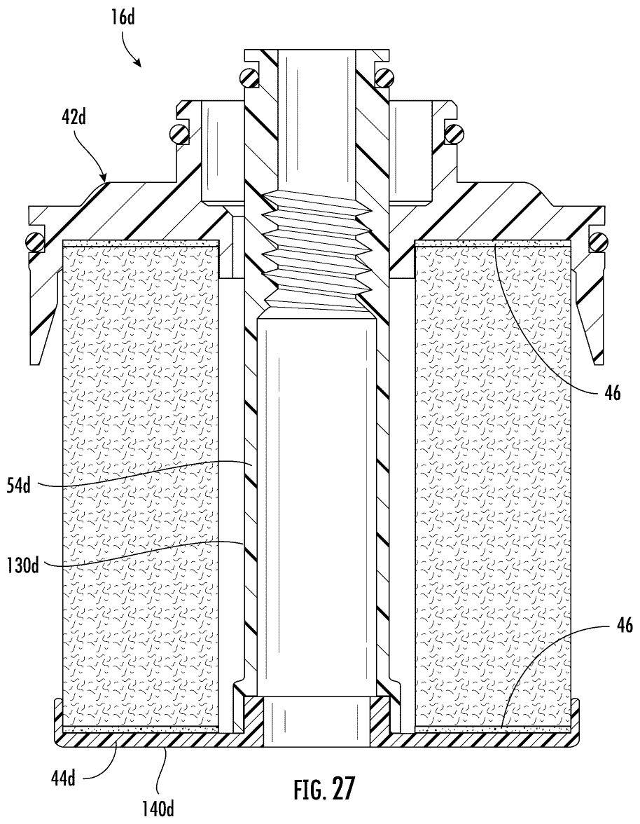

Overall, the central conduit is provided by respective portions of the upper end cap 42 and the lower end cap 44, with the upper end cap 42 providing the inlet entrance port 48 and the lower end cap defining a central opening to provide the inlet exit port 52, which is shown n FIG. 17 and also in FIGS. 15 and 26 (in which the upper end cap may be considered a composite of multiple pieces). Alternatively, the bottom end cap 42 can provide the entire conduit 54 as shown in FIG. 24, and/or an entire elongated center tube may be used for the entire conduit 54 as also shown in FIG. 27.

As noted above and in each of the embodiments (FIG. 17 and FIGS. 24-27), the upper end cap 42 comprises an annular disc portion 66 bonded to an upper end of the ring of filter media 40. The upper end cap 42, further comprises ribs 134 projecting radially inward from the annular disc portion 66 to an annular support region of the central conduit 54, wherein with one or more through ports 136 (best shown in FIG. 13) are defined by openings between adjacent ribs 134 communicating the outlet passageway 58 therethrough from a central filtered chamber inside of the ring of filter media 40 to the outlet port 50.

In the various embodiments illustrated, the inner annular wall 62 of the nipple portion 60 may also be an end portion of the central conduit 54.

Preferably the entire nipple portion 60 is unitary part with the upper end cap 42 as shown in FIG. 17 which also maintains precision/accuracy of the inner and outer annular walls 62, 64 (as shown a center tube portion 130 of the central conduit 54 and the annular disc portion 66 are formed as a single piece component).

In the various embodiments of FIG. 17, and FIGS. 24-27, the upper end cap 42 comprises the annular disc portion 66 that together with an inner annular retainer wall and an outer annular retainer wall that together define an upper annular potting well 138 (e.g., an annular channel) with adhesive sealing and bonding an upper end of the ring of filter media to the upper end cap. Similarly, the lower end cap 44 may comprise an annular disc portion 140, with an inner annular retainer wall and an outer annular retainer wall that together define a lower annular potting well 142 e.g., an annular channel), with adhesive sealing and bonding a lower end of the ring of filter media to the lower end cap. Alternatives to potting are discussed above.

While most of the focus has been of FIGS. 1-23 embodiments with some reference to alternatives in FIGS. 24-27, further discussion will be had as to FIG. 24-27, with it being understood the originally filed independent claims appended hereto are meant to encompass all figures including the alternatives of FIGS. 24-27, and it being understood that the discussion above for FIGS. 1-23 is applicable to FIGS. 24-27 and vice versa, as only the filter element has some modifications in the filtration assembly and the same parts/portions can have the same reference characters.

In the FIG. 24 embodiment of the filter element 16a, the central conduit 54a comprises a center tube portion 130a radially inside of the ring of filter media 40, with the center tube portion 54a being a unitary portion of the lower end cap 44a rather than upper end cap 42a.

In FIG. 25 embodiment of the filter element 16b, the central conduit 54b comprises a center tube portion 130b radially inside of the ring of filter media 40, with the center tube portion 130b being a separate tube member joined to the bottom end cap 42 and extending through an annular disc portion 66b of the upper end cap 42b (center tube portion 30 and/or upper portion thereof may also be considered a portion of the upper end cap).

In FIG. 26 embodiment of the filter element 16c, the upper end cap 42c is a composite end cap comprising two component parts 66c, 42c arranged together to provide the inlet entrance port 48 and the outlet port 50 at the upper end of the filter element. In this the central conduit 54c is provided by center tube component 130c of the upper end cap 44c, with the lower end thereof via the lower end cap 44.

In FIG. 27 embodiment of the filter element 16d, the central conduit 54d comprises a center tube portion 130d radially inside of the ring of filter media 40, with the center tube portion 130d joined to an annular disc portion 140d of the lower end cap 44d and extends through annular disc portions 66d, 140d of the upper and lower end caps 42d, 44d, respectively. The potting adhesive 46 may perform the bonding of the center tube 130d at the lower end cap 44d.

In FIGS. 1-27, the end caps 42, 44 can also be considered as and referred to as end cap assemblies, which may be one single unitary part or multiple component parts and/or portions thereof. “Assembly” indicates different portions are provided to provide for different functions in the part that connected together (either separate components or as unitarily formed), thereby to provide the end caps 42, 44. For example, different functions can include capping an end of a ring of media in one portion; defining/facilitating a flow path in another portion, spacing, providing a fluid port of some type, etc.

The central conduit 54 (which may be provided by either the upper end cap, lower end cap or a separate member as discussed above), can also service as a center support core for the ring of filter media 40 as generally shown and assist in prevent radially inward collapse of the filter media during liquid flow operations. This also facilitates a flow channel between the ring of media and the center support core to allow fluid to either exit or enter through the upper end cap.

As shown fluid flow is reversed with the inlet port inside of the outlet port, however, in some embodiments, the opposite may be true with the flow path reversed.

Finally, as shown in FIG. 4, and 20-21, the flow opening holes 100 in the center tube is located external to the ring of filter media. Optionally, the filter assembly can have flow opening holes 100 further up along the stem portion 90 of in the center tube as shown in FIG. 23 that as would be recognized to be located internal to the ring of filter media 40.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter element, comprising:
a ring of filter media;
an upper end cap and a lower end cap, with the ring of filter media extending between the upper end cap and the lower end cap;
an inlet entrance port and an outlet port at an upper end of the filter element, and an inlet exit port at a lower end of the filter element;
a central conduit extending inside the ring of filter media, the central conduit defining an inlet passageway passing through the upper end cap and the lower end cap and fluidically communicating between the inlet entrance port and the inlet exit port; and
an outlet passageway between the central conduit and the ring of filter media and fluidically communicating with the outlet port.

2. The filter element of claim 1, further comprising a threaded region defined by a radially inner surface of the central conduit along the inlet passageway.

3. The filter element of claim 2, further comprising an annular step region in the central conduit between the threaded region and the inlet exit port.

4. The filter element of claim 1, wherein: (a) the central conduit comprises a center tube portion radially inside of the ring of filter media, wherein the center tube portion is a unitary portion of the upper end cap, the center tube portion having a tubular end engaging the lower end cap; or (b) the central conduit is provided by respective portions of the upper end cap and the lower end cap, the upper end cap providing the inlet entrance port and the lower end cap defining a central opening to provide the inlet exit port; or (c) the upper end cap comprises an annular disc portion bonded to an upper end of the ring of filter media, further comprising ribs projecting radially inward from the annular disc portion to an annular support region of the central conduit, wherein a through port is defined by openings between adjacent ribs communicating the outlet passageway therethrough from a central filtered chamber inside of the ring of filter media to the outlet port.

5. The filter element of claim 1, further comprising a nipple portion, the nipple portion comprising an inner annular wall and an outer annular wall, the outer annular wall concentric with the inner annular wall, the inner annular wall and the outer annular wall projecting above an annular disc portion of the upper end cap, the inner annular wall being an end portion of the central conduit.

6. The filter element of claim 5, further comprising radial seals, including an outlet radial seal carried by the outer annular wall and an inlet radial seal carried by the inner annular wall, and an element radial seal carried by the upper end cap at a radial outer periphery of the upper end cap.

7. The filter element of claim 5, wherein the nipple portion is unitary part with the upper end cap, including being unitary with a center tube portion of the conduit and the annular disc portion as a single piece component, and wherein the upper end cap is a unitary single piece end cap unitarily providing both the inlet entrance port and the outlet port at the upper end of the filter element.

8. The filter element of claim 1, wherein the upper end cap provides a torsion lock detent along an upper surface thereof, and wherein the upper end cap provides a key along a radial outward facing periphery thereof.

9. The filter element of claim 1, wherein the central conduit is imperforate providing a leak-free path between the inlet entrance port and the and the inlet exit port.

10. The filter element of claim 1, wherein:
the upper end cap comprises an annular disc portion, an inner annular retainer wall and an outer annular retainer wall that together define an upper annular potting well, further comprising adhesive sealing and bonding an upper end of the ring of filter media to the upper end cap; and
the lower end cap comprises an annular disc portion, an inner annular retainer wall and an outer annular retainer wall that together define a lower annular potting well, further comprising adhesive sealing and bonding a lower end of the ring of filter media to the lower end cap.

11. The filter element of claim 1, wherein: (a) the central conduit comprises a center tube portion radially inside of the ring of filter media, wherein the center tube portion is a unitary portion of the lower end cap; or (b)
the central conduit comprises a center tube portion radially inside of the ring of filter media, wherein the center tube portion is a separate tube member joined to the bottom end cap and extending through an annular disc portion of the upper end cap, or (c) the upper end cap is a composite end cap comprising two component parts arranged together to provide the inlet entrance port and the outlet port at the upper end of the filter element.

12. The filter element of claim 1, wherein the central conduit comprises a center tube portion radially inside of the ring of filter media, wherein the center tube portion is joined to an annular disc portion of the lower end cap and extends through annular disc portions of the upper and lower end caps, respectively.

13. A filter cartridge comprising the filter element of claim 1, and further comprising:
a mounting bowl comprising a cylindrical sidewall and a bottom end wall that together define an element chamber, the cylindrical sidewall having a mounting thread, the bottom end wall defining a central drain opening;
wherein the filter element is installed into the element chamber in spaced relation to the bottom end wall to provide a drain chamber between the filter element and the bottom end wall, with a seal between the filter element and the cylindrical sidewall of the mounting bowl to prevent fluid leakage from the bowl;
a drain valve mounted through the central drain opening and having a stem portion engaging the central conduit of the filter element, the stem portion extending from a knob that resides on the outside of the mounting bowl.

14. The filter cartridge of claim 13, wherein the filter element comprises a threaded region defined by a radially inner surface of the central conduit along the inlet passageway, and wherein the stem portion comprises a mating thread engaging the threaded region such that the drain valve can be screwed and axially driven between an open position allowing drainage of fluid from the central drain opening and closed position sealing the central drain opening and the element chamber, and thereby sealing off a valve port between an exterior of the stem portion and an inner face of the central drain opening.

15. The filter cartridge of claim 13, wherein the filter element is removably mounted into the bowl and not permanent therewith such that the filter element is disposable and the bowl is reusable. and further comprising a keyed arrangement including a key projection and a key slot on the filter element and the mounting bowl, respectively or vice versa, the keyed arrangement rotationally locking the filter element and the mounting bowl.

16. A filtration assembly for filtering liquid comprising the filter cartridge of claim 13, further comprising:
a filter header comprising:
(a) a base portion defining an unfiltered inlet and a filtered outlet, the unfiltered inlet communicating unfiltered liquid to the inlet entrance port and the outlet port communicating filtered liquid to the unfiltered outlet; and
(b) a mounting rim extending from the base portion defining a rim thread for mating and engaging with the mounting thread to releasably mount the filter cartridge to the filter header; wherein the filter header further comprises concentric cylindrical inner and outer fluid connection walls connected to the unfiltered inlet and the filtered outlet, respectively, and
wherein the filter element comprises a nipple portion, the nipple portion comprising an inner annular wall and an outer annular wall, the outer annular wall concentric with the inner annular wall, the inner annular wall and the outer annular wall projecting above an annular disc portion of the upper end cap, and wherein the inner annular wall sealingly engages the cylindrical inner fluid connection wall and the outer annular wall sealingly engages the cylindrical outer fluid connection wall.

17. A filter element, comprising:
a ring of filter media;
an upper end cap and a lower end cap, with the ring of filter media extending between the upper end cap and the lower end cap;
a central conduit extending through the filter media providing a first passageway centrally through the filter element along an interior of the conduit and providing a second passageway along an exterior of the conduit toward one end of the filter element; and
a threaded region defined by a radially inner surface of the central conduit along the first passageway.

18. The filter element of claim 17, wherein the first passageway is an inlet passageway for unfiltered fluid and the second passageway is an outlet passageway for filtered fluid, wherein the filter element has a predetermined flow path through the inlet passageway then through the ring of filter media, and then through outlet passageway.

19. The filter element of claim 17, further comprising an annular step region in the central conduit between the threaded region and the inlet exit port.

20. The filter element of claim 17, wherein the central conduit comprises a center tube portion radially inside of the ring of filter media, wherein the center tube portion is a unitary portion of the upper end cap, the center tube portion having a tubular end engaging the lower end cap.

21. A filter element, comprising:
i) a ring of media, ii) upper and lower end cap assemblies, each of which includes a central annular body portion, and iii) a center support core;
a flow channel between the ring of media and the center support core, and a flow opening in the central body portion of the upper end cap assembly into the flow channel;
the upper end cap and/or the center support core including an internal threaded segment;
a first O-ring supported around the periphery of a distal end of the center support core projecting outwardly away from the upper end cap assembly; a second O-ring supported around the periphery of a fluid tube radially-outwardly surrounding the center support core and also projecting outwardly away from the upper end cap assembly, the fluid and a third O-ring supported around the periphery of the central body portion of the first end cap assembly.
